(19) United States
(12) Patent Application Publication
(10) Pub. No.: US 2013/0034792 A1
(43) Pub. Date: Feb. 7, 2013

(54) FUEL CELL STACK AND MANUFACTURING METHOD THEREOF

(71) Applicants: Seung-Tae LEE, Yongin-si (KR); Jun-Won SUH, Yongin-si (KR); Ho-Jin KWEON, Yongin-si (KR); Jan-Dee KIM, Yongin-si (KR); Young-Sun KWON, Yongin-si (KR)

(72) Inventors: Seung-Tae LEE, Yongin-si (KR); Jun-Won SUH, Yongin-si (KR); Ho-Jin KWEON, Yongin-si (KR); Jan-Dee KIM, Yongin-si (KR); Young-Sun KWON, Yongin-si (KR)

(73) Assignee: SAMSUNG SDI CO., LTD., Yongin-si (KR)

(21) Appl. No.: 13/314,614

(22) Filed: Dec. 8, 2011

(30) Foreign Application Priority Data
Aug. 5, 2011 (KR) 10-2011-0078352

(51) Int. Cl. H01M 8/24; H01M 8/00

(52) U.S. Cl. 429/452; 429/535

(57) ABSTRACT

A fuel cell stack and a manufacturing method thereof are disclosed. The fuel cell stack has at least one unit cell. The unit cell includes a first electrode collector, a first electrode layer formed on the first electrode collector, an electrolyte layer formed on the first electrode layer, a second electrode layer formed on the electrolyte layer, and a second electrode collector formed on the second electrode layer. At least one of the first and second electrode collectors may include a porous metal substrate having a density in a range from about 800 kg/m³ to about 1600 kg/m³ and a plurality of metal wires electrically connected to the porous metal substrate. The density of an electrode collector may be optimized to have an improved contact state between an electrode and the electrode collector. During operation, the fuel cell stack may thus have enhanced performance characteristics.

### CROSS-REFERENCE TO RELATED APPLICATIONS

This application claims priority to and the benefit of Korean Patent Application No. 10-2011-0078352, filed on Aug. 5, 2011, in the Korean Intellectual Property Office, the entire content of which is incorporated herein by reference.

### BACKGROUND

1. Field

The present disclosure relates to a fuel cell stack and a manufacturing method thereof, and more particularly, to a fuel cell stack and a manufacturing method thereof, which can enhance performance of the fuel cell stack by improving the structure of an electrode collector.

2. Description of the Related Technology

Fuel cells are a high-efficiency, clean generation technology for directly converting hydrogen and oxygen into electric energy through an electrochemical reaction. Here, the hydrogen may be supplied from a hydrocarbon-based material such as natural gas, coal gas or methanol, and the oxygen may be supplied from ambient air. Such fuel cells are classified into an alkaline fuel cell (AFC), a phosphoric acid fuel cell (PAFC), a molten carbonate fuel cell (MCFC), a solid oxide fuel cell (SOFC) and a polymer electrolyte membrane fuel cell (PEMFC), depending on the kind of an electrolyte used.

Among these fuel cells, the SOFC is a fuel cell operated at a high temperature of between about 600 to 1000° C. The SOFC is widely used because the position of an electrolyte is easily controlled, there is no concern about the exhaustion of fuel, and \material lifetime is relatively long as compared with various types of conventional fuel cells.

In the SOFC, the shape of an electrode collector may be deformed during the insertion process for the electrode collector. Although the contact state of the electrode collector was initially satisfactory in the insertion process of an electrode collector, a non-contact portion may be formed due to the volume contraction of an electrode as the electrode is subjected to reduction processing. This non-contact portion formed between an electrode and the electrode collector can lead to decreased performance of the fuel cell stack.

### SUMMARY OF CERTAIN INVENTIVE ASPECTS

In a first aspect, a fuel cell stack and a manufacturing method thereof is provided. In some embodiments, an optimized density of an electrode collector improves a contact state between an electrode and an electrode collector. In some embodiments, the improved contact state enhances performance of the fuel cell stack.

In another aspect, a fuel cell stack having at least one unit cell is provided. The at least one unit cell includes, for example, a first electrode collector, a first electrode layer formed on the first electrode collector, an electrolyte layer formed on the first electrode layer, a second electrode layer formed on the electrolyte layer, and a second electrode collector formed on the second electrode layer.

In some embodiments, at least one of the first and second electrode collectors includes a porous metal substrate having a density in a range from about 800 kg/m³ to about 1600 kg/m³ and a plurality of metal wires electrically connected to the porous metal substrate. In some embodiments, the porous metal substrate is formed of a nickel felt. In some embodiments, the metal wires are formed between the outer circumferential surface of the porous metal substrate and the first electrode layer. In some embodiments, the metal wires are formed between the inner circumferential surface of the porous metal substrate and the second electrode layer. In some embodiments, the metal wires are formed of nickel. In some embodiments, the metal wires are arranged at an equal interval along the length direction of the unit cell.

In another aspect, a method of manufacturing a fuel cell stack includes, for example, forming at least one unit cell by sequentially laminating a first electrode collector, a first electrode layer, an electrolyte layer, a second electrode layer and a second electrode collector.

In some embodiments, at least one of the first and second electrode collectors includes a porous substrate having a density in a range from about 800 kg/m³ to about 1600 kg/m³ and a plurality of metal wires electrically connected to the porous substrate. In some embodiments, the porous metal substrate is formed of a nickel felt. In some embodiments, the metal wires are formed between the outer circumferential surface of the porous metal substrate and the first electrode layer. In some embodiments, the metal wires are formed between the inner circumferential surface of the porous metal substrate and the second electrode layer. In some embodiments, the metal wires are formed of nickel. In some embodiments, the metal wires are arranged at an equal interval along the length direction of the unit cell.

In another aspect, the density of an electrode collector is optimized, and a contact state between an electrode and the electrode collector is improved, thereby enhancing performance of the fuel cell stack.

### BRIEF DESCRIPTION OF THE DRAWINGS

The accompanying drawings, together with the specification, illustrate exemplary embodiments of the present disclosure, and, together with the description, serve to explain the principles of the present disclosure.

FIG. 1 is a cross-sectional view showing a unit cell structure of a solid oxide fuel cell (SOFC) stack according to an embodiment of the present disclosure.

FIG. 2 is a plan view showing a structure of an electrode collector in the SOFC stack according to the embodiment of the present disclosure.

FIG. 3A is a graph comparing pressure drops in the SOFC stack according to the embodiment of the present disclosure and an SOFC stack according to a comparative example.

FIG. 3B is a graph comparing voltage performances with respect to current densities in the SOFC stack according to the embodiment of the present disclosure and the SOFC stack according to the comparative example.

FIG. 4A is a graph comparing pressure drops for each density of electrode collectors in the SOFC stack according to the embodiment of the present disclosure and the SOFC stack according to the comparative example.

FIG. 4B is a graph comparing slopes of the pressure drops for each density of the electrode collectors in FIG. 4A.

FIGS. 5A and 5B are microscopic photographs showing a porous substrate of the electrode collector according to the embodiment of the present disclosure and a porous substrate of the conventional electrode collector, respectively.

### DETAILED DESCRIPTION OF CERTAIN INVENTIVE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although it has been described in the following embodiments of the present disclosure that a unit cell is formed in the shape of a hollow cylinder, the shape of the unit cell is not limited thereto. For example, the unit cell may be formed in the shape of a polygonal cylinder. Although it has been described in the following embodiments of the present disclosure that a solid oxide fuel cell (SOFC) is an anode-supported fuel cell as an example thereof, the SOFC according to the following embodiments of the present disclosure may be identically applied to a cathode-supported fuel cell.

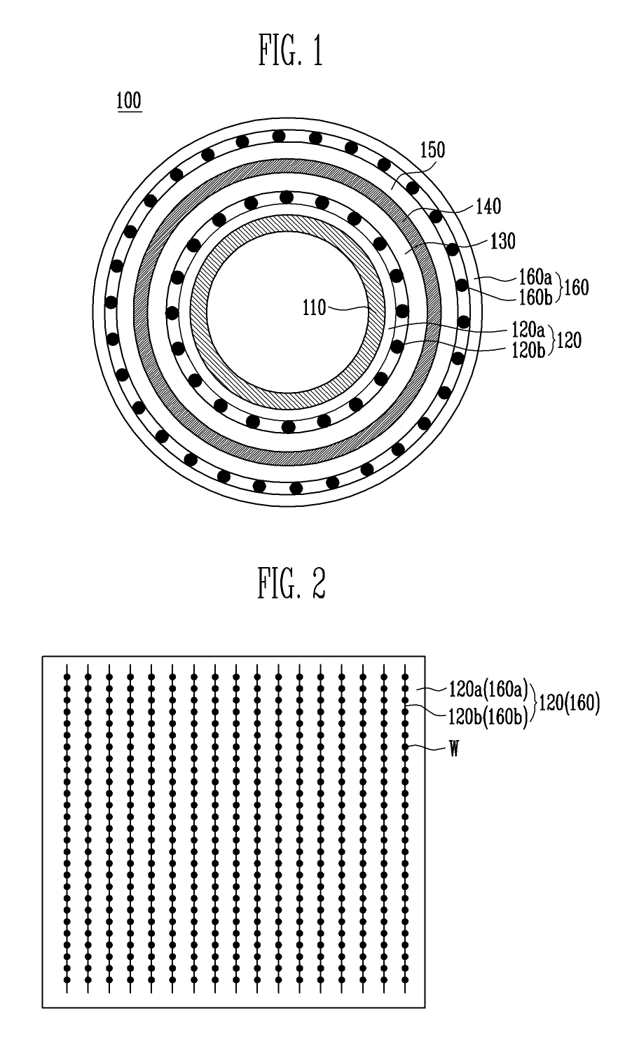

Hereinafter, an SOFC stack and a manufacturing method thereof according to embodiments of the present disclosure will be described with reference to FIGS. 1 to 5B.

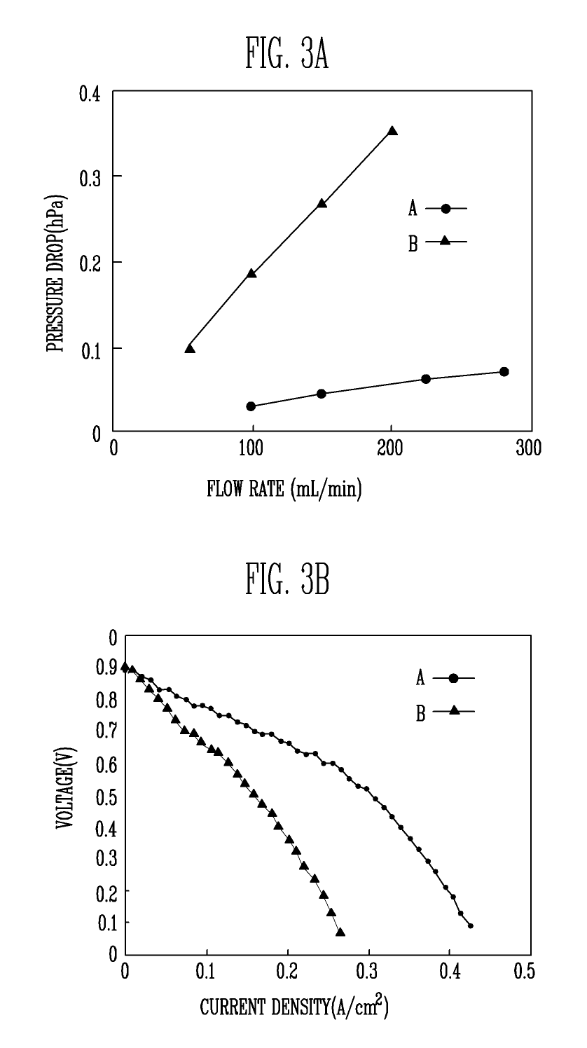

First, an SOFC stack and a manufacturing method thereof according to an embodiment of the present disclosure will be described with reference to FIGS. 1 and 2. FIG. 1 is a cross-sectional view showing a unit cell structure of an SOFC stack according to an embodiment of the present disclosure. FIG. 2 is a plan view showing a structure of an electrode collector in the SOFC stack according to the embodiment of FIG. 1.

Referring to FIGS. 1 and 2, the SOFC stack 100 according to this embodiment includes a unit cell 100 having a first electrode collector 120, a first electrode layer 130 formed on the first electrode collector 120, an electrolyte layer 140 formed on the first electrode layer 130, a second electrode layer 150 formed on the electrolyte layer 140, and a second electrode collector 160 formed on the second electrode layer 150, which are formed in a cylindrical shape. In a case where the first electrode layer 130 is an anode and the second electrode layer 150 is a cathode, the unit cell 100 generates electricity through an electrochemical reaction of hydrogen and oxygen. Here, the hydrogen is supplied through the first electrode layer 130 that is the anode, and the oxygen is supplied through the second electrode layer 150 that is the cathode.

The first electrode collector 120 may be formed on the inner circumferential surface of the first electrode layer 130, and the second electrode collector 160 may be formed on the outer circumferential surface of the second electrode layer 150. Thus, during operation of the unit cell the electricity generated from the unit cell 100 may be supplied to an external device or circuit through the first and second electrode collectors 120 and 160.

Here, the first electrode collector 120 formed on the inner circumferential surface of the first electrode layer 130 has a porous metal substrate 120a and a plurality of metal wires 120b. The metal wires 120b are arranged on the porous metal substrate 120a so as to be electrically connected to the porous metal substrate 120a.

The second electrode collector 160 formed on the outer circumferential surface of the second electrode layer 150 has a porous metal substrate 160a and a plurality of metal wires 160b. The metal wires 160b are arranged on the porous metal substrate 160a so as to be electrically connected to the porous metal substrate 160a.

Referring to FIG. 2, the metal wires 120b or 160b are welded so as to be electrically connected to the porous metal substrate 120a or 160a, thereby forming welding portions W. The metal wires 120b or 160b may be arranged at approximately equal intervals along the length direction of the unit cell 100.

The porous metal substrate 120a or 160a may be formed of a nickel felt. The density of the nickel felt may be within a range from about 800 kg/m³ to about 1600 kg/m³. The metal wire 120b or 160 may be formed of nickel.

Meanwhile, during manufacture of the device, a separate metal tube 110 may be inserted into the inside of the first electrode collector 120. This is because the metal tube 110 is inserted into the inside of the unit cell 100, so that the first electrode collector 120 can be fixed and adhered closely to the inner circumferential surface of the first electrode layer 130 and the strength of the unit cell 100 can also be improved.

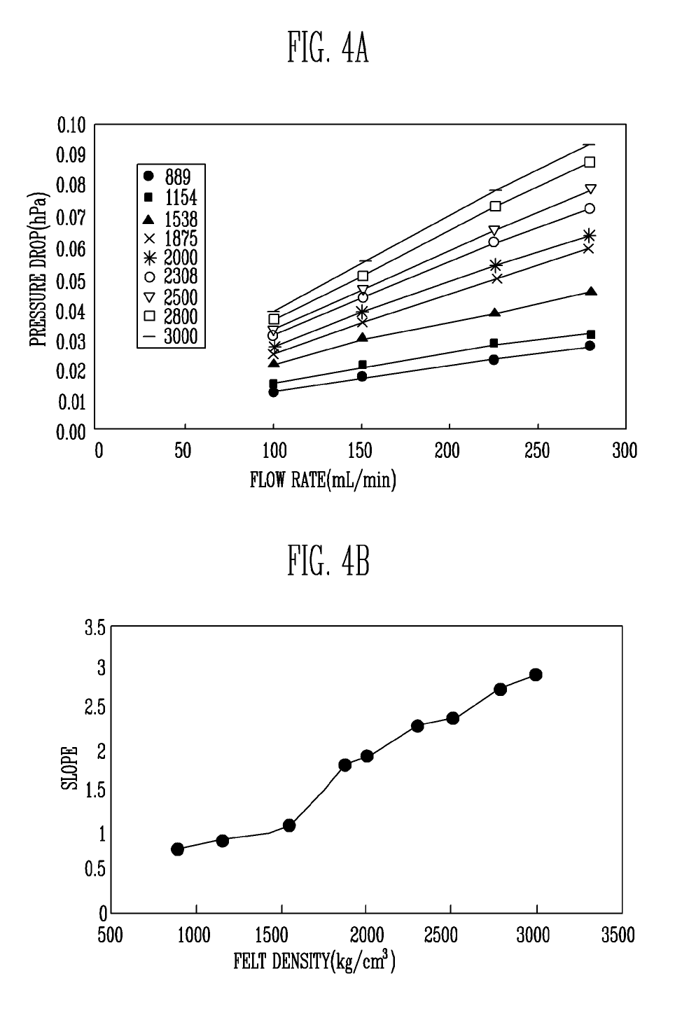

Hereinafter, characteristics of the SOFC stack according to the embodiment of the present disclosure and an SOFC stack according to a comparative example will be compared and described with reference to FIGS. 3A and 3B. FIG. 3A is a graph comparing pressure drops in the SOFC stack according to the embodiment of the present disclosure and an SOFC stack according to a comparative example. FIG. 3B is a graph comparing voltage performances with respect to current densities in the SOFC stack according to the embodiment of the present disclosure and the SOFC stack according to the comparative example.

In the graph shown in FIG. 3A, it can be seen that when a nickel foam is used as the porous metal substrate 120 or 160 according to the comparative example (B), the variation in pressure drop (hPa) according to the flow rate (ml/min) of hydrogen gas is greater than that when a nickel felt is used as the porous metal substrate 120a or 160a according to this embodiment (A). Also, it can be seen that the difference in variation between (B) and (A) is increased as the flow rate of the hydrogen gas is increased.

In the graph shown in FIG. 3B, it can be seen that when the nickel foam is used as the porous metal substrate 120 or 160 according to the comparative example (B), the variation in voltage drop according to the increase in current density (A/cm³) per unit area is greater than that when the nickel felt is used as the porous metal substrate 120a or 160a according to this embodiment (A).

When the density of the porous metal substrate 120a or 160a according to this embodiment is a suitable level like when the nickel felt is used (A), it is easy to handle the porous metal substrate 120a or 160a. The elasticity of the porous metal substrate 120a or 160a is increased so that the original shape of the porous metal substrate 120a or 160a may be more easily restored even after its shape is deformed, and thus it is advantageous in terms of contact resistance of the porous metal substrate 120a or 160a with the first or second electrode layer 130 or 150. Also, the variation in pressure drop according to the flow rate of hydrogen gas and the variation in voltage drop according to the increase in current density per unit area are decreased, and thus it is possible to enhance performance of the unit cell 100 and uniformly maintain the performance of the unit cell 100.

On the other hand, when the density of the porous metal substrate 120a or 160a according to this embodiment is higher than the suitable level like when the nickel foam is used (B), it is difficult to handle the porous metal substrate 120a or 160a. The fixed shape of the porous metal substrate 120a or 160a is not easily deformed, and therefore, it is disadvantageous in terms of the contact resistance of the porous metal substrate 120a or 160a with the first or second electrode layer 130 or 150. The variation in pressure drop according to the flow rate of hydrogen gas and the variation in voltage drop according to the increase in current density per unit area are increased. Therefore, the performance of the unit cell 100 is lowered, and it is difficult to uniformly maintain the performance of the unit cell 100.

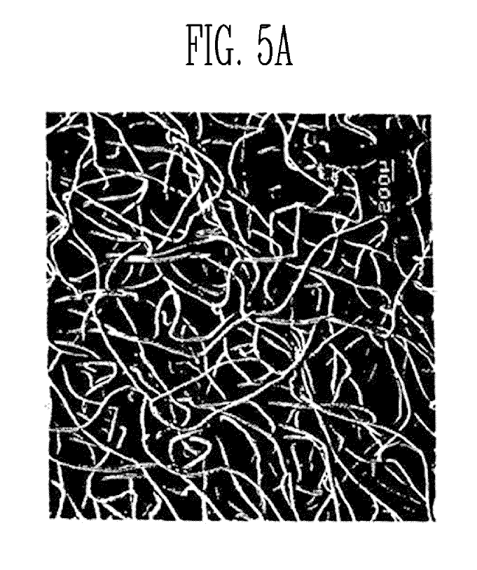

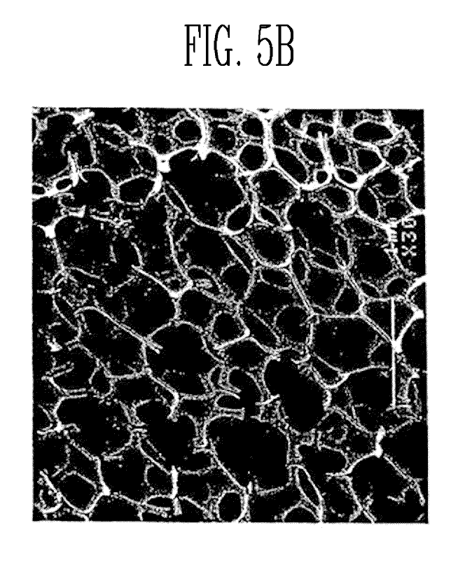

Hereinafter, characteristics of pressure drops for each density of electrode collectors in the SOFC stack according to this embodiment and the SOFC stack according to the comparative example will be compared and described with reference to FIGS. 4A to 4B. Also, microscopic photographs of porous substrates in the electrode collector according to this embodiment and the conventional electrode collector will be compared and described with reference to FIGS. 5A and 5B.

FIG. 4A is a graph comparing pressure drops for each density of electrode collectors with respect to flow rates in the SOFC stack according to the embodiment of the present disclosure and the SOFC stack according to the comparative example. FIG. 4B is a graph comparing slopes of the pressure drops for each density of the electrode collectors with respect to flow rates in FIG. 4A. FIGS. 5A and 5B are microscopic photographs showing a porous substrate of the electrode collector according to the embodiment of the present disclosure and a porous substrate of the conventional electrode collector, respectively.

Referring to FIG. 4A, it can be seen that under the condition of the same flow rate of hydrogen gas, the size of pressure drops in lower three graphs in which the density of the porous metal substrate 120a or 160a is relatively low is smaller than that of pressure drops in upper six graphs in which the density of the porous metal substrate 120a or 160a is relatively high. Also, it can be seen that as the flow rate of the hydrogen gas is increased, the variation in pressure drop is also increased. Thus, it can be expected that if the flow rate of the hydrogen gas is increased for the purpose of high-capacity electricity generation, the performance of the unit cell will be enhanced as the density of the porous metal substrate 120a or 160a is decreased within the limit in which the porous metal substrate 120a or 160a can perform the function of a substrate.

Referring to FIG. 4B, as a result showing slopes of pressure drops for each density of the electrode collectors with respect to the flow rates in FIG. 4A, the slope of the pressure drop is relatively gentle in the range from about that is the density of the nickel felt used as the porous metal substrate 120a or 160a according to this embodiment. Also, it can be seen that when the density of the nickel felt is greater than about 1600 kg/m³, the slope of the pressure drop is rapidly increased.

Referring to FIGS. 4A and 4B, the density of the nickel felt according to this embodiment is preferably formed to have a range from about 800 kg/m³ to about 1600 kg/m³. In this embodiment, when the density of the nickel felt used as the porous metal substrate 120a or 160a according to this embodiment is formed to have the range described above, it is possible to enhance performance of the unit cell 100 and uniformly maintain the performance of the unit cell 100.

Referring to FIGS. 5A and 5B, the nickel foam has an open-cell metal structure having high porosity. The nickel foam is formed by coating nickel on an open-cell polymer substrate such as a polyurethane foam in the high-temperature controlled air, removing the polymer substrate and then firing the coated nickel. Since the shape of pores formed in the nickel foam is similar to that of pores in sponge, the size of the pores is greater than that of the nickel felt, and the distance between pores is closer than that of the nickel felt. When comparing the nickel felt with the nickel foam, the nickel felt has a porous fibrous metal structure. The nickel felt is formed by coating nickel on a polymer substrate such as a polyester felt in the high-temperature controlled air, removing the polymer substrate and then firing the coated nickel. Since the shape of pores formed in the nickel felt is similar to that of pores formed in a mesh or net, the size of the pores is smaller than that of the nickel foam, and the distance between pores is longer than that of the nickel foam. More specifically, the nickel foam has a structure in which wires with a certain size are regularly connected to one another at a certain interval like sponge. On the other hand, the nickel felt has a structure in which wires with a certain size are stacked in several layers while being irregularly tangled with one another. Therefore, in the nickel felt, the distance between the wires may be shorter than that of the nickel foam, and thus the size of the pores becomes comparatively small.

Thus, when the nickel felt is used as the porous metal substrate 120a of the first electrode collector 120 or the porous metal material 160a of the second electrode collector 160, the arrival distance of current formed in the first or second electrode layer 130 or 150 to the first or second electrode collector 120 or 160 is shorter than when a nickel foam is used, even though the nickel felt has the same density as the nickel foam. Thus, it is possible to reduce loss of current and enhance performance of the fuel cell stack 100.

Although it has been described in the aforementioned embodiment that the nickel felt is applied to the first and second electrode collectors, the present disclosure is not limited thereto. For example, the nickel felt may be applied to only the first electrode collector, or may be applied to only the second electrode collector. According to the present disclosure, the density of an electrode collector may be optimized, so that it is possible to improve a contact state between an electrode and the electrode collector, thereby enhancing performance of the fuel cell stack.

Further, although it has been described in the aforementioned embodiments of the present disclosure that a unit cell is formed in the shape of a hollow cylinder, the shape of the unit cell is not limited thereto. For example, the unit cell may be formed in the shape of a polygonal cylinder.

While the present invention has been described in connection with certain exemplary embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A fuel cell stack having at least one unit cell comprising a first electrode collector, a first electrode layer formed on the first electrode collector, an electrolyte layer formed on the first electrode layer, a second electrode layer formed on the electrolyte layer, and a second electrode collector formed on the second electrode layer, wherein at least one of the first and second electrode collectors comprises a porous metal substrate having a density in a range from about 800 kg/m³ to about 1600 kg/m³ and a plurality of metal wires electrically connected to the porous metal substrate.

2. The fuel cell stack of claim 1, wherein the porous metal substrate is formed of a nickel felt.

3. The fuel cell stack of claim 1, wherein the metal wires are formed between the outer circumferential surface of the porous metal substrate and the first electrode layer.

4. The fuel cell stack of claim 1, wherein the metal wires are formed between the inner circumferential surface of the porous metal substrate and the second electrode layer.

5. The fuel cell stack of claim 1, wherein the metal wires are formed of nickel.

6. The fuel cell stack of claim 1, wherein the metal wires are arranged at an equal interval along the length direction of the unit cell.

7. A method of manufacturing a fuel cell stack, comprising forming at least one unit cell by sequentially laminating a first electrode collector, a first electrode layer, an electrolyte layer, a second electrode layer and a second electrode collector, wherein at least one of the first and second electrode collectors comprises a porous substrate having a density in a range from about 800 kg/m³ to about 1600 kg/m³ and a plurality of metal wires electrically connected to the porous substrate.

8. The method of claim 7, wherein the porous metal substrate is formed of a nickel felt.

9. The method of claim 7, wherein the metal wires are formed between the outer circumferential surface of the porous metal substrate and the first electrode layer.

10. The method of claim 7, wherein the metal wires are formed between the inner circumferential surface of the porous metal substrate and the second electrode layer.

11. The method of claim 7, wherein the metal wires are formed of nickel.

12. The method of claim 7, wherein the metal wires are arranged at an equal interval along the length direction of the unit cell.
